(19) United States
(12) Patent Application Publication
(10) Pub. No.: US 2013/0288717 A1
(43) Pub. Date: Oct. 31, 2013

(54) AUGMENTED REALITY (AR) TARGET UPDATING METHOD, AND TERMINAL AND SERVER EMPLOYING SAME

(71) Applicant: Jaehyuk Choi, Anyang-si (KR)

(72) Inventor: Jaehyuk Choi, Anyang-si (KR)

(73) Assignee: LG ELECTRONICS INC, Seoul (KR)

(21) Appl. No.: 13/978,104

(22) PCT Filed: Jan. 17, 2012
(86) PCT No.: PCT/KR12/00397

§ 371 Date: Jul. 2, 2013

Related U.S. Application Data
(60) Provisional application No. 61/433,266, filed on Jan. 17, 2011.

(51) Int. Cl. H04W 4/02

(52) U.S. Cl. CPC H04W 4/02
USPC 455/456.3

(57) ABSTRACT

There is provided a method for updating an AR target of a terminal, the method comprises: receiving an AR target, a boundary distance for a coverage area of the AR target, and the at least one area ID list from a server; if precise positioning is possible, determining whether or not the location of the terminal satisfies a boundary condition on the basis of the boundary distance; if precise positioning is impossible, determining whether or not the serving cell ID of the terminal satisfies the boundary condition on the basis of said the at least one area ID list; and, if it is determined that the boundary condition is satisfied, transmitting an update request from the AR target to the server.

### TECHNICAL FIELD

This specification relates to a method of updating an AR target and a terminal and server adopting the same.

### BACKGROUND ART

Augmented Reality (AR) service is service for reinforcing and providing pieces of additional information that are difficult to be obtained by only the real world by composing cyber things on the basis of the real world. In mobile AR service, additional information is added to real things seen by the camera of a terminal through information about the current location and direction of the terminal and shown.

Common mobile AR service is a method in which a terminal requests, from a server, an AR target (or AR content) including contents necessary for a user in the current location of the terminal and provides the requested AR target or uses an AR target previously stored in the terminal. This method is disadvantageous in that seamless mobile AR service is not provided to a user who uses consecutive mobile AR service.

### DISCLOSURE

### Technical Problem

Embodiments disclosed in this specification have been made to solve the above-described problem, and there are provided a method of updating an AR target stored in the cache of a terminal in order to provide a user with seamless mobile AR service and a method of previously downloading an AR target of an area that is substantially necessary for a user, and a terminal and server adopting the same.

### Technical Solution

A method of a terminal updating an AR target according to an embodiment disclosed in this specification includes the steps of receiving an AR target, a boundary distance for a coverage area of the AR target, and at least one area ID list from a server; determining whether or not the location of the terminal satisfies a boundary condition based on the boundary distance if precise positioning is possible; determining whether or not the serving cell ID of the terminal satisfies the boundary condition based on the at least one area ID list if the precise positioning is impossible; and sending an update request for the AR target to the server if it is determined that the boundary condition is satisfied.

In an embodiment, the at least one area ID list includes an entire area ID list included in the coverage area and a boundary area ID list corresponding to the boundary of the coverage area.

Furthermore, in an embodiment, the boundary condition is satisfied if the serving cell ID of the terminal is included in both the entire area ID list and the boundary area ID list.

Furthermore, in an embodiment, the at least one area ID list includes an outer area ID list corresponding to the boundary of the coverage area and an inner area ID list corresponding to the inside of the boundary of the coverage area.

Furthermore, in an embodiment, the boundary condition of the terminal is satisfied if the serving cell ID of the terminal is included in the outer area ID list and is not included in the inner area ID list.

Furthermore, in an embodiment, the at least one area ID list includes an area ID list corresponding to the inside of the coverage area.

Furthermore, in an embodiment, the boundary condition of the terminal is satisfied if the serving cell ID of the terminal is not included in the area ID list corresponding to the inside of the coverage area.

Furthermore, in an embodiment, the at least one area ID list includes a boundary area ID list corresponding to the coverage area.

Furthermore, in an embodiment, the boundary condition of the terminal is satisfied if the serving cell ID of the terminal is included in the boundary area ID list.

Furthermore, in an embodiment, the boundary condition of the terminal is satisfied if a distance between a location of the terminal at a point of time at which the AR target has been requested and a current location of the terminal is greater than or equal to the boundary distance.

Furthermore, in an embodiment, the boundary condition of the terminal is satisfied if a radius of the coverage area is greater than a sum of the distance between the location of the terminal at the point of time at which the AR target has been requested and the current location of the terminal and the boundary distance.

Meanwhile, a method of a server updating an AR target according to another embodiment disclosed in this specification includes the steps of receiving an update request for the AR target from a terminal, wherein the request includes a moving direction and motion state of the terminal; determining whether or not the terminal substantially satisfies a boundary condition based on the moving direction of the terminal; generating an AR target based on the moving direction and motion state of the terminal if the terminal substantially satisfies the boundary condition; and sending the generated AR target to the terminal.

In an embodiment, the step of generating the AR target includes the step of filtering the AR target, determining the coverage area of the AR target, or determining the resolution of the AR target based on the motion state of the terminal.

Furthermore, in an embodiment, the boundary condition is substantially satisfied if the moving direction of the terminal is a direction becoming distant from the center of a coverage area of the AR target.

Furthermore, in an embodiment, the step of generating the AR target includes the step of limiting a coverage area of the AR target based on the moving direction of the terminal.

### Advantageous Effects

The present invention provides an AR target in a predetermined area, facilitates a method of a terminal itself providing a proper AR target according to a movement of a user, and can increase efficiency of network resources and reduce a load of a server as compared with an existing method of a server on a network continuing to provide an AR target according to a movement of a user.

Furthermore, seamless AR service can be provided to a user who uses AR service through mobile and thus user experiences can be increased because an AR target stored in a terminal is predicted in advance before the AR target gets out of an area where the AR target is covered and a necessary and new AR target is requested and received before an AR target gets out of a corresponding area.

### DESCRIPTION OF DRAWINGS

FIG. 1 is a block diagram showing an AR system (AR eco-system) in accordance with an embodiment disclosed in this specification.

FIG. 2 is a block diagram showing interfaces used in the AR system (AR eco-system) in accordance with an embodiment disclosed in this specification.

FIG. 3 is a schematic flowchart illustrating a process of providing an AR target in accordance with an embodiment disclosed in this specification.

FIGS. 4a to 4d are diagrams showing various methods of a terminal 100 determining a boundary condition using an area ID in accordance with an embodiment of the present invention.

FIGS. 5 and 6 are diagrams showing a method of the terminal 100 determining a boundary condition using a boundary distance in accordance with an embodiment of the present invention.

FIGS. 7 to 9 are diagrams illustrating a request/response process for previously updating an AR target stored in the terminal 100 in accordance with an embodiment of the present invention.

FIGS. 10 and 11 are flowcharts illustrating the AR target update process of the terminal 100 in accordance with an embodiment of the present invention.

FIG. 12 is a block diagram of the terminal 100 and a server 200 in accordance with an embodiment disclosed in this specification.

### MODE FOR INVENTION

The characteristics and preferred embodiments of the present invention are described in detail below with reference to the accompanying drawings.

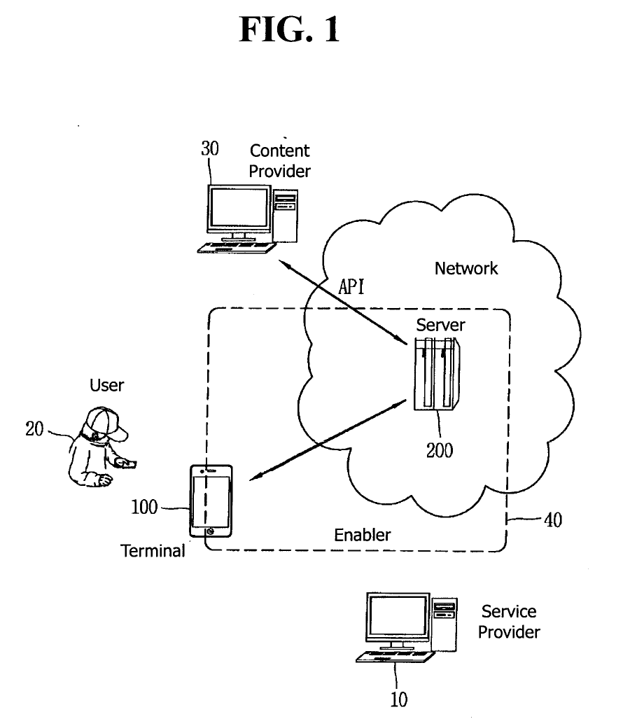

FIG. 1 is a block diagram showing an AR system (AR eco-system) in accordance with an embodiment disclosed in this specification.

In Augmented Reality (AR), interactive media is combined with the real world, and points of time and experiences in the real physical world are augmented by cyber digital objects by an electronic device.

In AR, a new paradigm of interactivity in which common experiences recognized by a user when the user obtains (searches for) information are suddenly changed. Since the augmentation of reality is real-time and situational, AR is practically interactive, can be opened up digitally, and is meaningful and available.

To use the location and direction of the camera of a mobile terminal enables various scenarios in which AR technology is determined by network locations of GPS and OMA SUPL and the locations of devices, such as a compass and various sensors of a mobile terminal.

All elements shown in FIG. 1 take a change of a new AR paradigm.

A service provider 10 generates new and attractive mobile AR service and provides the generated mobile AR service to a user through a mobile AR enabler 40.

A user 20 has a lot of experiences while moving and easily finds useful information about luxurious amenities and surrounding reality.

A content provider/publisher 30 has a new opportunity to provide content and information. Owing to information including phenomena affecting a new digital era, it is necessary to classify pieces of content better and to filter and synthesize the pieces of content in order to simplify access to the content and the consumption of the content and to guarantee search for the content.

The mobile AR enabler 40 can guarantee the exchange of pieces of AR content between cross-platforms and common access to the AR content by proving a new mechanism for the generation, publication, transmission, filtering, and personalization of the AR content.

In the following description, AR content refers to a multimedia object used to augment/enhance the perception of a user for the real world, such as a picture, video, text, a 3-D model, and audio.

Furthermore, an AR marker refers to a digital object that is displayed on a screen indicative of the availability of AR content regarding an AR target.

Furthermore, the AR target refers to an entity in the real world that may be associated with AR content, such as Point Of Interest (POI), a product, a person, and a car.

Furthermore, an AR view refers to a point of time provided by an application that supports AR content so that a user can see the AR content overlapped with a camera video stream on a screen.

Furthermore, personalization refers to the processing of custom-tailored AR content based on user information. Personalization can imply the use of estimation regarding a user which can be distributed over, for example, many static data and/or a user profile, and preference. Furthermore, contextualization refers to the processing of custom-tailored AR content based on specific user context. Contextualization can imply the use of estimation regarding user context, such as many dynamic data and/or, for example, a location and performance.

Furthermore, user context refers to dynamic information set indicative of a current common state of a user and surrounding environments of the user. The information set can be searched for from various sources including an OMA enabler.

Furthermore, an AR App. is an external entity residing in a device. The AR App. requests and receives AR content from a mobile AR client and provides the AR content to a user. Furthermore, the AR App. reports AR metrics data to the mobile AR client.

Furthermore, the mobile AR client is a device-side function component of the mobile AR enabler 40 and is installed in a terminal 100. The mobile AR client resides in the terminal 100.

Furthermore, the content provider means an entity that provides content.

Furthermore, a mobile AR server is a network-side function component of the mobile AR enabler 40 and is installed in a server 200. The mobile AR server resides in the server 200.

Furthermore, an API is an abbreviation of an Application Programming Interface, AR is an abbreviation of Augmented Reality, MobAR is an abbreviation of Mobile Augmented Reality, POI is an abbreviation of Point Of Interest, DM is an abbreviation of a Data Matrix, and QR is an abbreviation of a Quick Response.

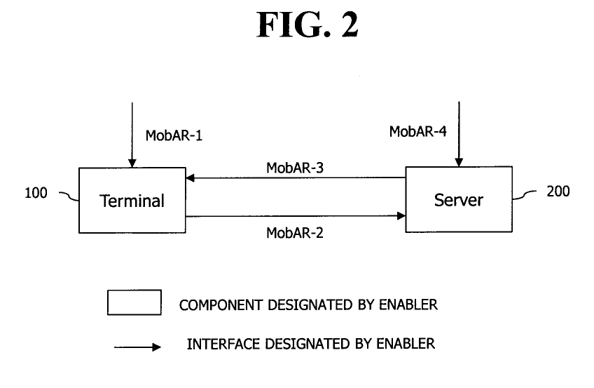

FIG. 2 is a block diagram showing interfaces used in the AR system (AR eco-system) in accordance with an embodiment disclosed in this specification.

A MobAR-1 interface is an interface exposed to an AR App. by a mobile AR client. The AR App. requests and obtains AR content from the mobile AR client using this interface and reports AR metrics data to the mobile AR client.

A MobAR-2 interface is an interface exposed to the mobile AR client by a mobile AR server. The mobile AR client requests and obtains AR content from the mobile AR server using this interface and reports AR metrics data to the mobile AR server.

The MobAR-2 interface requests AR content/an AR target based on filters, such as a category, location information, a search range, a direction, a consumption method, screen resolution, and user preferences, and various criteria, such as detailed information about an AR target.

Furthermore, the MobAR-2 interface subscribes to AR content push or terminates subscription based on filters, such as a category, location information, a search range, a direction, a consumption method, screen resolution, and user preferences, and various criteria, such as detailed information about an AR target.

Furthermore, the MobAR-2 interface sets/updates user preferences, such as a search range, a category, a push filter, and metrics collection (enable/disable).

Furthermore, the MobAR-2 interface sends proper AR metrics and user feedback (e.g., a grade) collected in order to take future AR content selection into consideration.

A MobAR-3 interface is an interface exposed to the mobile AR server by a mobile AR client. The mobile AR client receives AR content through this interface from the mobile AR server through a basic push transfer mechanism. The mobile AR server may inform the mobile AR client of information, such as enable/disable metrics and collection, through this interface.

The MobAR-3 interface transfers the direct push of AR content for subscription and requests the indirect notice of AR content for subscription.

A MobAR-4 interface is an interface exposed to the content provider by the mobile AR server. The content provider provides AR content to the mobile AR server and uses this interface to access functions provided by the mobile AR server. In general, this interface is exposed in the form of an API.

The MobAR-4 interface requests to publish the availability of AR content.

The MobAR-4 interface deploys AR targets and requests to establish or release an association between AR content and a specific AR target.

The MobAR-4 interface designates the deployment rules of AR content, such as the start time and delay time of AR content deployment, a different AR content association using a user or the same AR target based on time, and access control over premium content (including them, but not limited thereto).

Furthermore, the MobAR-4 interface accesses anonymous feedback related to a user interaction and metrics (e.g., for AR content improvement).

A procedure generated between the mobile AR client and the server is as follows.

The mobile AR client subscribes to the mobile AR server in order to use mobile AR service. When the subscription is performed for the first time, this procedure is not necessary afterward. The mobile AR client requests the use of the mobile AR service from the mobile AR server (i.e., service request). This request includes the type of service to be used by the mobile AR client. In order to be provided with content suitable for its device, the mobile AR client informs the mobile AR server of device capabilities (i.e., exchange of device capabilities). Capabilities that can be supported by the mobile AR server can also be provided to the mobile AR client, if necessary. The mobile AR client requests and receives a real AR target necessary to use the service (i.e., content request/response). This step may be generated several times depending on the type of service. The requested service between the mobile AR client and the mobile AR server is terminated (i.e., service termination).

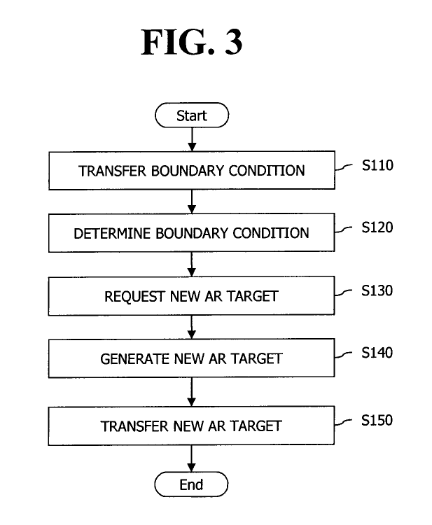

FIG. 3 is a schematic flowchart illustrating a process of providing an AR target in accordance with an embodiment disclosed in this specification.

In accordance with the process of providing an AR target according to an embodiment disclosed in this specification, in order to provide seamless AR service to a user, the terminal 100 in which an AR target (or also called AR content hereinafter) is previously stored predicts a situation in which a user gets out of an area covered by the previously stored AR target before the user gets out of the area, requests an AR target within an area where the user is expected to be placed from the server 200 in advance, and receives the requested AR target from the server 200. This process is described in more detail below.

First, when providing an AR target to the terminal 100, the server 200 provides the terminal 100 with a boundary condition along with information about an area covered by the AR target (S110).

Thus, the terminal 100 compares a current state with the boundary condition provided by the server 200 and determines whether or not the current state is a situation in which the terminal 100 can get out of the area covered by the AR target previously stored by a user (S120).

Furthermore, if the terminal 100 determines that the current state is a situation in which it can get out of the area covered by the AR target previously stored by the user, the terminal 100 requests a new AR target from the server 200 (S130). Here, the terminal 100 sends information, such as a moving direction or motion state of the terminal 100, to the server 200.

The server 200 selects an AR target to be provided to the terminal 100 based on the information received from the terminal 100 (S140).

The server 200 provides the selected AR target to the terminal 100. Here, the server 200 provides a new boundary condition along with information about an area covered by the provided AR target (S150).

A method of determining various boundary conditions and determining whether or not a current state is a situation in which the terminal can get out of an area covered by an AR target previously stored by a user and a method, information transmitted from the terminal to the server when the terminal requests an AR target, and a method of the server using the information are described below.

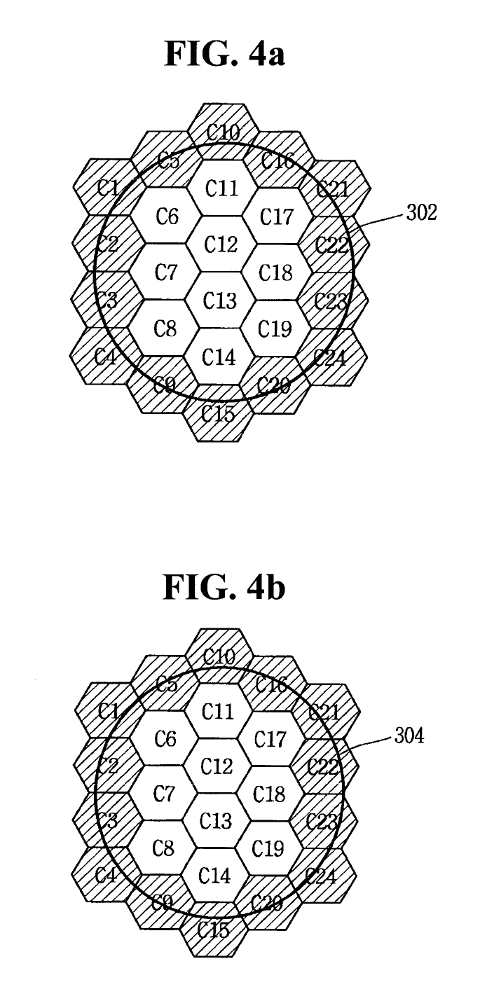

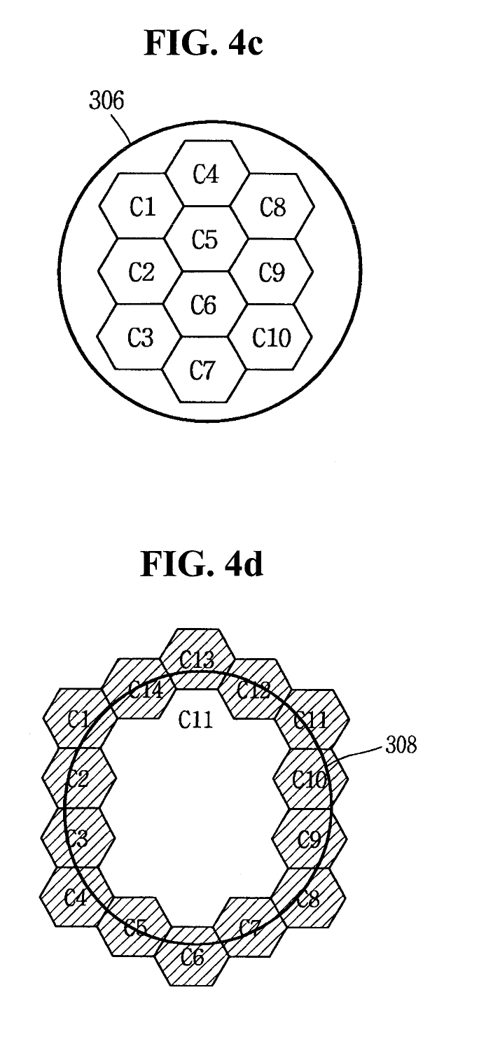

FIGS. 4a to 4d are diagrams showing various methods of the terminal 100 determining a boundary condition using an area ID in accordance with an embodiment of the present invention.

Referring to FIGS. 4a to 4d, the terminal 100 can determine a point of time at which an AR target will be updated using an area ID. Here, the area ID is one of representation methods indicative of an area (the area ID is the identity of an area in a wireless network) and can be configured through information about the cell ID of a network. Cell IDs and area IDs for respective networks are shown in Tables 1 to 8 below.

Table 1 below shows cell IDs and area IDs for GSM.

TABLE 1

| | PARAMETER | VALUE/DESCRIPTION |
|---|---|---|
| Cell | Gsm Cell Info | GSM cell ID |
| ID | >MCC | Mobile Country Code, range: (0 . . . 999) |
| | >MNC | Mobile Network Code, range: (0 . . . 999) |
| | >LAC | Location Area Code, range: (0 . . . 65535) |
| | >CI | Cell Identity, range: (0 . . . 65535) |
| Area | GSM Area Id | Mobile Country Code or Mobile Country Code + |
| ID | | Mobile Network Code or Mobile Country Code + |
| | | Mobile Network Code + Location Area Code |
| | | or Cell Global Identity |

Furthermore, Table 2 below shows cell IDs and area IDs for WCDMA/TD-SCDMA.

TABLE 2

| | PARAMETER | VALUE/DESCRIPTION |
|---|---|---|
| Cell | Wcdma/TD-SCDMA | WCDMA/TD-SCDMA cell ID |
| ID | Cell Info | |
| | >MCC | Mobile Country Code, range: (0 . . . 999) |
| | >MNC | Mobile Network Code, range: (0 . . . 999) |
| | >UC-ID | Cell Identity, range: (0 . . . 268435455) Note: this information |
| | | element includes Cell Identity transmitted by SIB3 [3GPP |
| | | RRC]. |
| | >Cell Parameters ID | Cell Parameters ID, range: (0 . . . 127) Note: this field is |
| | | applied to only TD-SCDMA. Note: frequency information |
| | | and Cell Parameters ID are always frequency information |
| | | and Cell Parameters ID of a current cell. Note: this |
| | | parameter is mandatory for TD-SCDMA. |
| Area | WCDMA/TD- | Mobile Country Code or Mobile Country Code + Mobile |
| ID | SCDMA Area Id | Network Code or Mobile Country Code + Mobile Network |
| | | Code + Location Area Code or Mobile Country Code + |
| | | Mobile Network Code + Location Area Code + Cell Identity |

Furthermore, Table 3 below indicates cell IDs and area IDs for LTE.

TABLE 3

| | PARAMETER | VALUE/DESCRIPTION |
|---|---|---|
| Cell ID | LTE Cell Info | LTE cell ID. parameter defined in |
| | | [3GPP 36.321] |
| | >CellGlobalIdEUTRA | |
| | >>PLMN-Identity | |
| | >>>MCC | Mobile Country Code, range: |
| | | (0 . . . 999) |
| | >>>MNC | Mobile Network Code, range: |
| | | (0 . . . 999) |
| | >>CI | Cell Identity, length 28 bits. |
| | >PhysCellId | Physical cell ID), range: (0 . . . 503) |
| | >TrackingAreaCode | Tracking Area Code, length 16 bits |
| Area ID | LTE Area Id | MCC or MCC + MNC or MCC + |
| | | MNC + Cell-ID |

Furthermore, Table 4 below indicates cell IDs and area IDs for CDMA.

TABLE 4

| | PARAMETER | VALUE/DESCRIPTION |
|---|---|---|
| Cell ID | Cdma Cell Info | CDMA cell ID |
| | >NID | Network ID, range: (0 . . . 65535) |
| | >SID | System ID, range: (0 . . . 32767) |
| | >BASEID | Base Station ID, range: (0 . . . 65535) |
| | >BASELAT | Base Station Latitude), range: (0 . . . 4194303) |
| | >BASELONG | Base Station Longitude, range: (0 . . . 8388607) |
| | >REFPN | Base Station PN Number, range: (0 . . . 511) |
| Area ID | CDMA Area Id | System ID or System ID + Network |
| | | ID or System ID + Network ID + Base ID |

Furthermore, Table 5 below indicates cell IDs and area IDs for HRPD.

TABLE 5

| | PARAMETER | VALUE/DESCRIPTION |
|---|---|---|
| Cell ID | Hrpd Cell Info | HRPD cell ID |
| | >SECTORID | Sector ID), length 128 bits |
| | >BASELAT | Base Station Latitude, range: (0 . . . 4194303) |
| | >BASELONG | Base Station Longitude, range: (0 . . . 8388607) |
| | >WeekNumber | GPS Week number, range: (0 . . . 65535) |
| | >Seconds | GPS Seconds, range: (0 . . . 4194303) |
| Area ID | HRPD Area Id | Sector ID |

Furthermore, Table 6 below indicates cell IDs and area IDs for UMB.

TABLE 6

| | PARAMETER | VALUE/DESCRIPTION |
|---|---|---|
| Cell ID | Umb Cell Info | UMB the cell ID |
| | >SECTORID | Sector ID, length 128 bits |
| | >MCC | Mobile Country Code, range: (0 . . . 999) |
| | >MNC | Mobile Network Code, range: (0 . . . 999) |
| | >BASELAT | Base Station Latitude, range: (0 . . . 4194303) |
| | >BASELONG | Base Station Longitude, range: (0 . . . 8388607) |
| Area ID | UMB Area Id | Sector ID or Sector ID + MNC or |
| | | Sector ID + MCC |

Furthermore, Table 7 below indicates cell IDs and area IDs for a WLAN AP.

TABLE 7

| | PARAMETER | VALUE/DESCRIPTION |
|---|---|---|
| Cell ID | WLAN AP Info | WLAN Access Point ID |
| | >AP MAC Address | Access point MAC Address |
| | >AP Reported Location | Location of an Access Point as |
| | | reported by an AP |
| | >>Location Encoding | ASN.1 in LCI[X.694] in location |
| | | encoding description[RFC 3825] |
| | >>Location Data | Location data |
| | >>>Location Accuracy | Location accuracy in 0.1 m unit |
| | >>>Location Value | Location value of a form defined in |
| | | location encoding |
| Area ID | WLAN Area Id | APMACAddress |

Furthermore, Table 8 below indicates cell IDs and area IDs for WiMAX.

TABLE 8

| | PARAMETER | VALUE/DESCRIPTION |
|---|---|---|
| Cell ID | WiMAX BS Info | WiMAX Base Station Info |
| | >BS ID | Fixed length bit string of a base |
| | | station identifier 48 |
| | >> BS Location | Location of a BS reported by the |
| | | BS |
| | >>>Location Encoding | ASN.1 in LCI[X.694] in location |
| | | encoding description[RFC 3825] |
| | >>>>Location Data | Location Data |
| | >>>>>Location Accuracy | Location Accuracy in 0.1 m unit |
| | | (integer) (0 . . . 4294967295) |
| | >>>>>Location Value | Fixed length octet string of a |
| | | location value 128 of a form |
| | | defined in location encoding |
| Area ID | WiMAX Area Id | BS ID |

The server 200 also provides the terminal 100 with the area ID of an area covered by an AR target when providing the AR target to the terminal 100. The terminal 100 compares the received area ID and its own serving cell and determines a point of time at which the AR target will be updated. For example, when providing an AR target to the terminal 100, the server 200 also provides the terminal 100 with a list of area IDs of an area covered by the AR target. The area ID list can be configured as in Table 9 below.

TABLE 9

| PARAMETER NAME | DESCRIPTION |
|---|---|
| Area ID list | Includes one or more area IDs and consists of |
| | the entire area ID list and a boundary area ID |
| | list |
| > Entire area ID list | A set of all area IDs in an area covered by a |
| | provided AR target |
| > Boundary area ID list | A set of area IDs near the boundary of an area |
| | covered by a provided AR target |

Referring to FIG. 4a, the entire area ID list is a set of all area IDs of an area 302 covered by a provided AR target and is C1 to C24. The boundary area ID list is a set of area IDs near the boundary of the area 302 covered by the provided AR target, and it includes C1, C2, C3, C4, C5, C9, C10, C15, C16, C20, C21, C22, C23, and C24. The terminal 100 continue to compare its own serving cell ID with the area IDs provided by the server 200 while mobile AR service is in progress. Operations according to the results of the area ID comparison are defined as in Table 10 below.

TABLE 10

| Results of | Results of | |
|---|---|---|
| com- | comparison | |
| parison | with | |
| with entire | boundary | |
| area | area ID | |
| ID list | list | Description |
| match | mismatch | The terminal 100 continues to perform an area |
| | | ID comparison operation because it is within an |
| | | area covered by an AR target. |
| match | match | The terminal 100 requests AR target update |
| | | from the server 200 because it is placed at the |
| | | edge of an area covered by an AR target and |
| | | will soon gets out of the area covered by the |
| | | AR target. |
| mismatch | mismatch | The terminal 100 requests AR target update |
| | | from the server 200 because it has gotten out of |
| | | an area covered by an AR target. |

According to the operation shown in Table 10, the terminal 100 can check a point of time at which a stored AR target will be updated.

The area ID list may be differently configured as in Table 11 below.

TABLE 11

| PARAMETER | |
|---|---|
| NAME | DESCRIPTION |
| Area ID list | Includes one or more area IDs and consists of an |
| | inner area ID list and an outer area ID list. |
| > Inner area ID list | A set of area IDs entering an area covered by a |
| | provided AR target |
| > Outer area ID | A set of area IDs near the boundary of an area |
| list | covered by a provided AR target |

Referring to FIG. 4b, the inner area ID list is a set of area IDs entering an area 304 covered by a provided AR target and it includes C6, C7, C8, C11, C12, C13, C14, C17, C18, and C19. An outer area ID list is a set of area IDs near at the boundary of the area 304 covered by the provided AR target, and it includes C1, C2, C3, C4, C5, C9, C10, C15, C16, C20, C21, C22, C23, and C24. The terminal 100 continues to compare its own serving cell ID with the area IDs provided by the server 200 while mobile AR service is in progress. Operations according to the results of the area ID comparison are defined as in Table 12 below.

TABLE 12

| Results of | | |
|---|---|---|
| com- | Results of | |
| parison | comparison | |
| with | with | |
| inner area | outer area | |
| ID list | ID list | Description |
| match | mismatch | The terminal 100 continues to perform an area |
| | | ID comparison operation because it is within an |
| | | area covered by an AR target. |
| mismatch | match | The terminal 100 requests AR target update |
| | | from the server 200 because it is placed at the |
| | | edge of an area covered by an AR target and |
| | | will soon gets out of the area covered by the |
| | | AR target. |
| mismatch | mismatch | The terminal 100 requests AR target update |
| | | from the server 200 because it has gotten out of |
| | | an area covered by an AR target. |

The area ID list may be differently configured as in Table 13 below.

TABLE 13

| Parameter name | Description |
|---|---|
| Area ID list | A set of area IDs entering an area covered by a |
| | provided AR target |

Referring to 4c, the area ID list is a set of area IDs entering an area 306 covered by a provided AR target, and it includes C1 to C10. The terminal 100 compares its own serving cell ID with the area IDs provided by the server 200 while mobile AR service is in progress. Operations according to the results of the area ID comparison are defined as in Table 14 below.

TABLE 14

| Results of comparison | |
|---|---|
| with area ID list | Description |
| Match | The terminal 100 continues to perform an area |
| | ID comparison operation because it is within |
| | an area covered by an AR target. |
| mismatch | The terminal 100 requests AR target update |
| | from the server 200 because it has gotten out |
| | of an area covered by an AR target. |

The area ID list may be differently configured as in Table 15 below.

TABLE 15

| Parameter | |
|---|---|
| name | Description |
| Area ID list | A set of area IDs near the boundary of an area covered |
| | by a provided AR target |

Referring to 4d, the area ID list is a set of area IDs near the boundary of an area 308 covered by a provided AR target, and it includes C1 to C14. The terminal 100 compares its own serving cell ID with the area IDs provided by the server 200 while mobile AR service is in progress. Operations according to the results of the area ID comparison are defined as in Table 16 below.

TABLE 16

| Results of | |
|---|---|
| comparison with | |
| area ID list | Description |
| match | The terminal 100 requests AR target update from |
| | the server 200 because it is placed at the edge of an |
| | area covered by an AR target and will soon gets out of |
| | the area covered by the AR target. |

As shown in FIGS. 4a to 4d, the terminal 100 may expect that a user will soon get out of an area covered by an AR target and receive a necessary AR target from the server 200 in advance before the user gets out of the area covered by the AR target. In another embodiment, the terminal 100 may request an AR target when the terminal 100 gets out of an area covered by an AR target. In this embodiment, when providing an AR target to the terminal 100, the server 200 may provide a set of area IDs of all areas, covered by the AR target to the terminal 100, as the entire area ID list. Or, as described with reference to FIG. 4c, when the server 200 provides a set of area IDs, entering an area covered by an AR target, as the entire area ID list, the terminal 100 may compare its own serving cell ID with the provided area ID list and request a new AR target from the server 200 when the own serving cell ID is not matched with the provided area ID list.

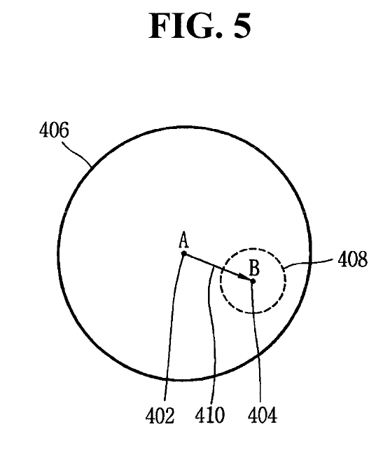

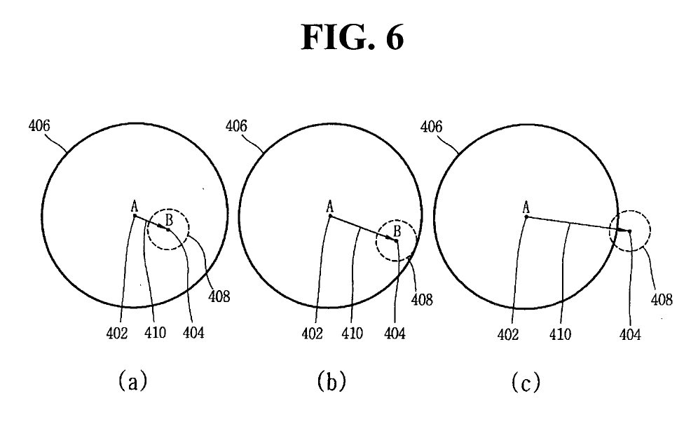

FIGS. 5 and 6 are diagrams showing a method of the terminal 100 determining a boundary condition using a boundary distance in accordance with an embodiment of the present invention.

Referring to FIGS. 5 and 6, the terminal 100 determines whether or not the terminal 100 is in a situation in which the terminal 100 can get out of an area 406 covered by an AR target using a distance between the initial location 402 and the current location 404 of the terminal 100. Here, the initial location 402 of the terminal 100 means the location of the terminal 100 at a point of time when the terminal 100 has requested the AR target.

Referring to 5, the terminal 100 requests the server 200 from an AR target [symbol] at a point A. Here, the terminal 100 provides the server 200 with information about the location of the terminal 100 (i.e., information about the location of the point A). The server 200 transfers an AR target which can cover a specific area 406 to the terminal 100 on the basis of the location (i.e., point A) of the terminal 100. The terminal 100 shows AR targets within its own search range 408, from among AR targets received from the server 200, to a user.

FIGS. 6(a) to 6(c) are diagrams illustrating the determination of a boundary condition according to the current location of the terminal 100.

Referring to FIG. 6(a), the search range 408 of the terminal 100 is now within the area 406 covered by an AR target. Referring to FIG. 6(b), the search range 408 of the terminal 100 is now within the area 406 covered by the AR target (also near the area 406) and it is expected that the search range 408 of the terminal will soon get out of the boundary of the area 406 covered by the AR target. Referring to 6(c), the search range 408 of the terminal 100 has gotten out of the area 406 covered by the AR target.

The terminal 100 can check whether the terminal 100 corresponds to any situation of FIGS. 6(a) to 6(c) based on a distance between the initial location (point A) and the current location (point B) of the terminal 100. That is, the terminal 100 may determine when an AR target will be updated based on a distance between the initial location (point A) and the current location (point B) of the terminal 100. When the radius of the area 406 covered by the AR target and the radius of the search range 408 of the terminal 100 are checked, the terminal 100 can update the AR target from the server 200 according to a distance between the initial location (point A) and the current location (point B) of the terminal 100 (e.g., when the distance is threshold or higher). The radius of the area 406 covered by the AR target can be checked by the server 200 that generates the AR target, and the terminal 100 can transfer the radius of the search range 408 of the terminal 100 to the server 200. While mobile AR service is provided, the terminal 100 continues to calculate a distance between 410 the initial location (point A) and the current location (point B) of the terminal 100 and compares the calculated value with a boundary distance on which the AR target needs to be updated. If, as a result of the comparison, a condition is satisfied, the terminal 100 may request the update of the AR target from the server 200.

If the radius of the area 406 covered by the AR target is defined to be R, the search range 408 of the terminal 100 is defined to be r, the boundary distance on which the AR target needs to be updated is defined to be C, and a distance between the initial location 402 and the current location 404 of the terminal 100 is defined to be c, the operations of the terminal 100 according to the results of the distance comparison are defined as in Table 17 below.

TABLE 17

| Results of distance | |
|---|---|
| comparison | Operation of the terminal 100 |
| C > c | Continue to perform a distance comparison process |
| C = c or C < c | AR target update request |

The terminal 100 can request the update of the AR target from the server 200 according to the values of R, r, and C at points of time defined in Table 18 below.

TABLE 18

| Distance condition | Description |
|---|---|
| R > C + r | Method of the terminal 100 updating a |
| | necessary AR target in advance before |
| | getting output of the area 406 covered |
| | by an AR target |
| R = C + r or R < C + r or R = C | Method of the terminal 100 updating |
| | a necessary AR target when it gets out |
| | of the area 406 covered by an AR target |

That is, the terminal 100 transfers the radius of its own search range 408 to the server 200. The terminal 100 can transfer a radius of its own search range 408 to the server 200 at a point of time at which the terminal 100 requests the server 200 to provide an AR target or at a point of time at which the terminal 100 transfers its own capabilities to the server 200. Furthermore, the terminal 100 requests the AR target from the server 200. Here, the terminal 100 requests the AR target including its own current location (i.e., the initial location 402). The terminal 100 may transfer the radius of its own search range 408 to the server 200 and at the same time request the AR target from the server 200.

The server 200 generates an AR target to be transferred to the terminal 100 based on the current location 404 of the terminal 100 that has been received from the terminal 100. Here, the server 200 generates a boundary condition (the boundary condition is represented by the length) on which the AR target needs to be updated by taking the range of the area covered by the AR target and the radius of the search range 408 of the terminal 100 into consideration. The server 200 transfers the generated AR target and the boundary condition to the terminal 100.

While mobile AR service is provided, the terminal 100 calculates a location of the terminal 100 at a point of time at which the terminal 100 has requested the AR target from the server 200, that is, a distance between the initial location 402 and the current location 404, and compares the calculated distance with the boundary condition received from the server 200. If the boundary condition received from the server 200 is satisfied (i.e., the calculated distance is matched with the boundary condition), the terminal 100 requests the update of the AR target from the server 200.

The method using an area ID, described with reference to FIGS. 4a to 4d, and the method using a distance between the initial location and the current location of the terminal 100, described with reference to FIGS. 5 and 6, have been described above as a method of determining a point of time at which an AR target stored in the terminal 100 will be updated. The two methods have advantages and disadvantages. The method using an area ID can be used to directly determine a point of time at which an AR target will be updated without using additional precise positioning (e.g., GPS) and can be used irrespective of the interior and exterior of a room. In contrast, the method using a distance between the initial location and the current location of the terminal 100 has high precision because it is based on precise positioning (GPS), but the method requires precise positioning (GPS) and thus the method cannot be used in the interior of a room where precise positioning (GPS) is impossible.

Accordingly, if the terminal 100 supports both the two methods and a proper method of the two methods can be used according to circumstances, a mutual supplementation effect is generated. For example, when providing an AR target to the terminal 100, the server 200 provides the terminal 100 with a boundary distance along with an area ID. When the terminal 100 is placed in the interior of a room where precise positioning is impossible, the terminal 100 can determine a point of time at which an AR target will be updated according to the method using area ID. In an area where precise positioning is possible, the terminal 100 can perform precise positioning and determine a point of time at which an AR target will be updated based on a distance between the initial location and the current location of the terminal 100.

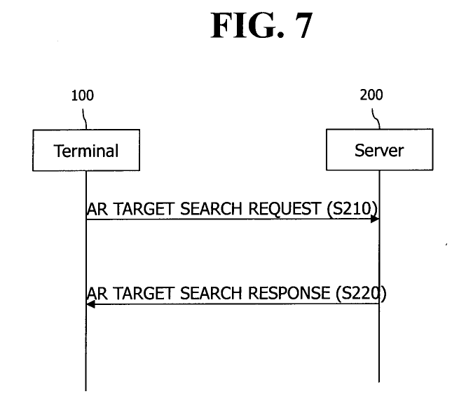

FIGS. 7 to 9 are diagrams illustrating a request/response process for previously updating an AR target stored in the terminal 100 in accordance with an embodiment of the present invention.

FIG. 7 is a diagram illustrating a request/response process for previously updating an AR target stored in the terminal 100 according to a common method.

The terminal 100 requests an AR target from the server 200 (S210). The request message includes condition information about the AR target to be received by the terminal 100. In general, when the terminal 100 requests the AR target from the server 200, information included in the message includes screen resolution, a supported media type, a search range, a consumption style, and location information.

The server 200 generates an AR target to be provided to the terminal 100 based on the condition information about the AR target that has been received from the terminal 100 and provides the generated AR target to the terminal 100 (S220).

A condition on which an AR target to be provided can be efficiently selected in a method of the terminal 100 previously downloading the AR target in a necessary area from the server 200 is described below.

A motion state described below indicates a current motion state of the terminal 100. The motion state can indicate any one of, for example, stationary, pedestrian, running, cycling, a car, a train, an aeroplane, a boat, and fidgeting (refer to OMA LPPe v1.0 TS).

The motion state is not a value generated by a single function (e.g., a single sensor) within the terminal 100, but is a value that can be inferred through the output values of various sensors, such as an acceleration system, a gyro sensor, and a compass within the terminal 100. To this end, there is a need for a method (algorithm) for inferring a motion state using values outputted from respective sensors, and a different algorithm suitable for the characteristics of a sensor needs to be applied to a different terminal 100 because the same sensor has different characteristics depending on a chip used therein or a state. This algorithm can be any one of a various known algorithms. As a result, the terminal 100 can obtain a motion state using various known algorithms and values outputted from various sensors within the terminal 100. As an alternative, a user may directly input a motion state to the terminal 100, a user application may directly generate a motion state, or the terminal 100 may generate and use the value.

An example in which the motion state is used is shown in Table 19 below.

TABLE 19
When surrounding restaurant information is checked through
AR service

| Motion | |
|---|---|
| state | Provided service |
| Pedestrian | Introduction of restaurants, restaurant open/close time, |
| | provided menus, and pedestrian navigation service from a |
| | current point to a corresponding restaurant by foot |
| Car | Introduction of restaurants, restaurant open/close time, |
| | provided menus, whether or drive-in is possible, whether |
| | or not a parking lot is present, whether or not parking |
| | is currently possible, and car navigation service from a |
| | current point to a corresponding restaurant |

Meanwhile, when generating an AR target, the server 200 can determine an area covered by the AR target to be provided to the terminal 100 through a motion state. If a motion state of a user is cycling or a car rather than stationary or pedestrian, the server 200 can provide the terminal 100 with an AR target which can cover a wider area. If moving speed is faster, the server 200 can provide the terminal 100 with AR targets having higher priority than many AR targets.

In order to use a motion state, the terminal 100 may include sensors (an acceleration system, a gyro sensor, and a compass) for providing information necessary to determine the motion state and an algorithm for determining a current motion state of a user based on values received from the sensors, determine the motion state of a user in advance a point of time at which AR service is requested or a point of time at which an AR target is requested, and include the results of the determination.

Furthermore, in order to use a motion state, the server 200 needs to add a motion state category to each AR target. The motion state category is shown in Table 20 below as an example.

TABLE 20

| | CONTENTS OF | |
|---|---|---|
| | AN AR TARGET TO | |
| | BE PROVIDED | MOTION STATE |
| A | Location, Menus provided, | Stationary, Pedestrian, Running, |
| Restaurant | Open/close time, etc. | Cycling |
| B Store | Location, Items, etc. | Stationary, Pedestrian, Running, |
| | | Cycling, Car |
| C | Location, Menus provided, | Stationary, Pedestrian, Running, |
| Restaurant | Open/close time, etc. | Cycling, Car |

Furthermore, the server 200 can include a function of filtering AR targets to be provided based on a motion state provided by the terminal 100 and a function of making different a cache area covered by an AR target depending on a motion state. For example, when the terminal 100 moves fast, the server 200 can provide the terminal 100 with an AR target covering a wide area. When the terminal 100 moves slowly, the server 200 can provide the terminal 100 with an AR target covering a relatively narrow area. Furthermore, the server 200 can make different the resolution of an AR target depending on a motion state. For example, when the terminal 100 moves slowly, the server 200 can provide an AR target in more detail (densely) (accordingly, a user can view more visual objects in the same range). When the terminal 100 moves fast, the server 200 provides an AR target simply (relatively less densely) (accordingly, a user can view less visual objects in the same range).

In an embodiment, transport means, such as a car, a train, an aeroplane, and a boat, may be taken into consideration in the above-described motion state. In this case, the server 200 can provide the terminal 100 with an AR target by taking transport means into consideration. For example, since moving speed of a user using a car may be faster than moving speed by foot, an area covered by an AR target may be widened or the resolution of the AR target may be increased as described above. However, the server 200 may check information about the destination of a user using various means (e.g., the reception of destination information from the terminal 100) and send an AR target for the destination to the terminal 100 prior to departure or while moving.

Likewise, if a user is in the airport, a motion state may be set as an aeroplane, the server 200 may check information about the destination of the user using various means (e.g., the reception of destination information from the terminal 100) and send an AR target for the destination to the terminal 100 prior to departure or while moving. Accordingly, user convenience can be increased as compared with a conventional method in which after a user reaches a destination, the terminal 100 receives an AR target.

the heading information described below refers to information about the direction along which a user now moves. The server 200 can determined that the terminal 100 moves in which direction based on the heading information. Based on heading information, the server 200 can provide the terminal 100 with an AR target having a better possibility (frequency) and may determine whether or not it is necessary to provide a new AR target.

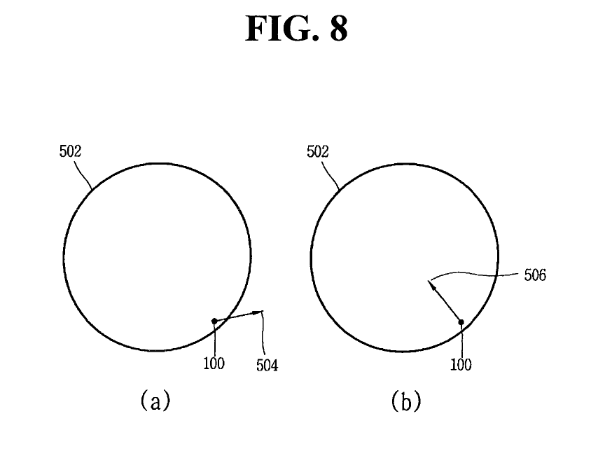

FIGS. 8(a) and 8(b) are conceptual diagrams showing a situation in which whether or not the terminal 100 placed in the same location will update an AR target is different based on heading information in accordance with an embodiment of the present invention.

Referring to FIGS. 8(a) and 8(b), the current location of the terminal 100 is placed insides near the boundary of an area 502 covered by an AR target. If heading information is not taken into consideration, the terminal 100 will request an AR target from the server 200 because the current location of the terminal 100 is placed at the boundary of the area 502 covered by the AR target. In response thereto, the server 200 will generate an AR target and provide the generated AR target to the terminal 100. If heading information is taken into consideration, however, whether or not to update the AR target is different in FIGS. 8(a) and 8(b).

That is, referring to FIG. 8(a), since a current moving direction 504 of the terminal 100 is a direction opposite to that of the area covered by the AR target, that is, a direction that becomes distant from the initial location (i.e., the center of the area covered by the AR target) of the terminal 100, if the terminal 100 requests an AR target from the server 200, the server 200 can generate an AR target and provide the generated AR target to the terminal 100. This is because there is a good possibility that the terminal 100 will soon get out of the area covered by the AR target as it becomes far from the initial location.

In contrast, referring to FIG. 8(b), since a current moving direction 506 of the terminal 100 is the same direction as that of the area covered by the AR target, that is, a direction that becomes close to the initial location (i.e., the center of the area covered by the AR target) of the terminal 100, the terminal 100 may not request an AR target from the server 200 or the server 200 may not provide the terminal 100 with an AR target although the terminal 100 requests an AR target from the server 200. This is because there is a poor possibility that the terminal 100 will soon get out of the area covered by the AR target as it becomes close to the initial location.

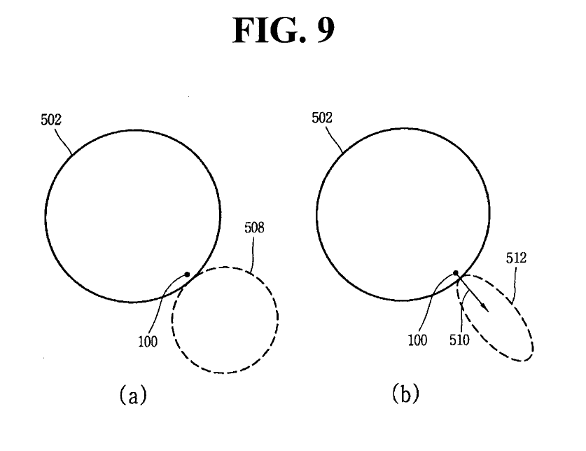

FIGS. 9(a) and 9(b) are conceptual diagrams showing a situation in which an area covered by an AR target is different based on heading information in the terminal 100 placed in the same location in accordance with an embodiment of the present invention.

Referring to FIGS. 9(a) and 9(b), the server 200 may provide the terminal 100 with an AR target that is expected to have high use frequency of the terminal 100 based on heading information.

FIG. 9(a) is a diagram showing an area covered by an AR target when the terminal 100 does not provide the server 200 with heading information. In this case, the server 200 provides the terminal 100 with an AR target that can cover a wide area including an area to which the terminal 100 is expected to move. That is, the server 200 can provide the terminal 100 with an AR target that can cover a specific area 508 (an area having a specific size or shape) irrespective of a moving direction of a user.

FIG. 9(b) is a diagram showing an area covered by an AR target when the terminal 100 provides the server 200 with heading information. In this case, the server 200 can limit an expected area because it can expect a direction along which the terminal 100 will move and provide an AR target in relation to the limited area. That is, the server 200 changes an area 512 (the size or shape of the area) that can cover the AR target to be dynamically provided to the terminal 100 depending on a moving direction 510 of a user.

The method of using a motion state and heading information has been described above as a method of efficiently selecting an AR target to be provided when the server 200 receiving a request to provide a new AR target from the terminal 100 determines the new AR target to be provided to the terminal 100. In accordance with this method, the server 200 can efficiently provide an AR target to the terminal 100 because it can determine whether or not the terminal 100 actually needs a new AR target and also select an AR target according to a current situation of the terminal 100. This method may be used in a method of previously receiving AR targets within an area to which the terminal 100 is expected to move, but may be commonly used in a process in which the terminal 100 requests an AR target from the server 200.

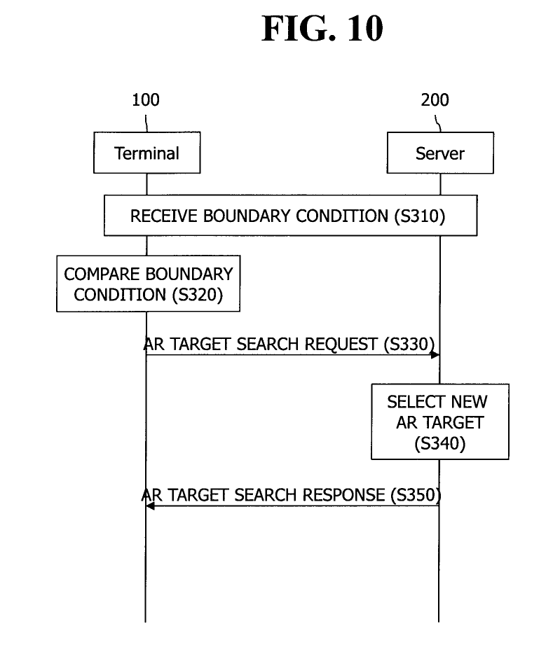

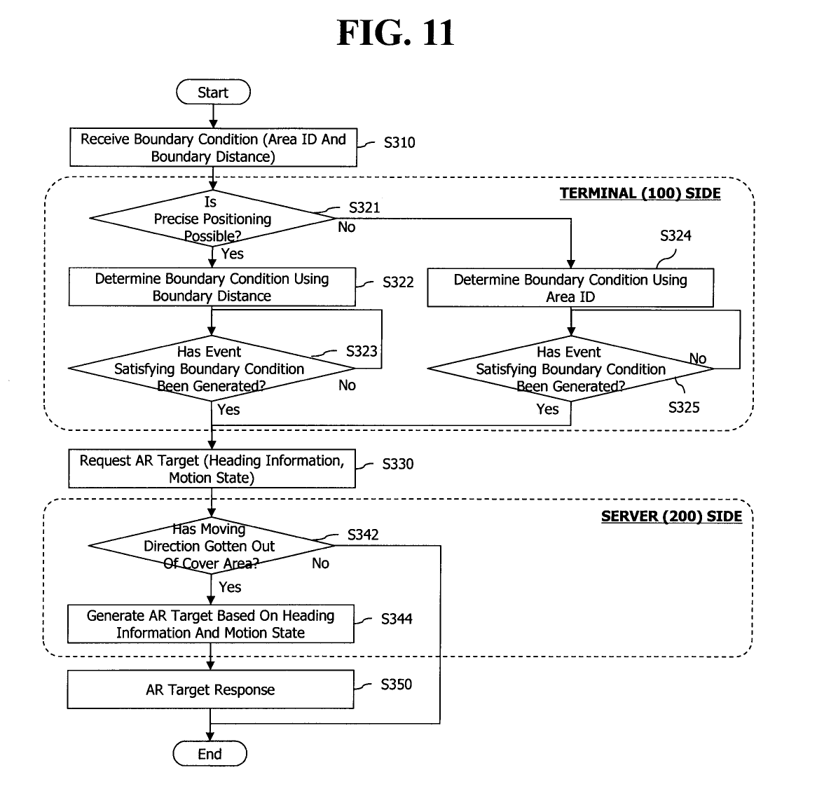

FIGS. 10 and 11 are flowcharts illustrating the AR target update process of the terminal 100 in accordance with an embodiment of the present invention.

FIG. 10 is a schematic flowchart illustrating the AR target update process of the terminal 100 in accordance with an embodiment of the present invention.

The terminal 100 stores an AR target and a boundary condition previously received from the server 200 and becomes a state in which the terminal 100 can use the stored AR state (S310).

Furthermore, the terminal 100 determines whether or not the terminal 100 will get out of an area covered by the AR target stored in the terminal 100 and/or whether or not it is expected that the terminal 100 will get out of an area covered by the AR target stored in the terminal 100 based on the boundary condition received from the server 200 (S320). The terminal 100 can determine the boundary condition using the method using an area ID and the method using a boundary distance as described above. If precise positioning using GPS is not available, the terminal 100 determines the boundary condition using a boundary distance. If precise positioning is impossible, the terminal 100 determines the boundary condition using an area ID.

When an event is generated at step S520, that is, when the terminal 100 gets out of the area covered by the stored AR target or if it is expected that the terminal 100 will get out of the area covered by the stored AR target, the terminal 100 requests an AR target, corresponding to an area to which the terminal 100 will move, from the server 200 (S330). This request message can include the location, search range, screen resolution, motion state, and heading information of the terminal 100.

The server 200 selects an AR target to be provided to the terminal 100 based on information received from the terminal 100 (S340). First, the server 200 determines whether or not the terminal 100 will get out of the area covered by the stored AR target based on the location and heading information of the terminal 100 (S342). If it is determined that the terminal 100 will not get out of the area covered by the stored AR target, the server 200 does not provide the terminal 100 with an AR target. If it is determined that the terminal 100 will get out of the area covered by the stored AR target, however, the server 200 selects a new AR target using the location, search range, screen resolution, motion state, and heading information of the terminal 100 received from the terminal 100 (S344). For example, the server 200 selects a new AR target in an area to which the terminal 100 is expected to move using the location and heading information of the terminal 100. Furthermore, the server 200 determines an AR target capable of covering an area having what size (or what shape) based on the motion state and the heading information.

The server 200 transfers the AR target, determined at step S340, to the terminal 100 (S350). Here, the server 200 also transfers a new boundary condition for the AR target transferred to the terminal 100.

FIG. 11 is a detailed flowchart illustrating the AR target update process of the terminal 100 in accordance with an embodiment of the present invention.

A description of steps S310, S330, and S350 shown in FIG. 11 is the same as the description of the steps S310, S330, and S350 shown in FIG. 10, and thus the description is omitted.

At step S320, the terminal 100 determines whether or not precise positioning using a GPS module is not possible (S321). For example, the terminal 100 determines whether or not the location of the terminal 100 can be precisely measured using a GPS module although the GPS module is not activated or the intensity of a measured GPS signal is lower than a threshold although the GPS module is activated.

If precise positioning is possible, the step S321 branches to step S322 in which the terminal 100 determines a boundary condition using a boundary distance (for a detailed description, refer to the description of FIGS. 5 and 6). This is because to determine the boundary condition using an area ID is much more precise than to determine the boundary condition using a boundary distance. At step S323, when an event satisfying the boundary condition is generated, for example, if it is expected that the terminal 100 will get out of the area covered by the AR target, the terminal 100 requests a new AR target from the server 200 (S330).

In contrast, if precise positioning is impossible, the step S321 branches to step S324 in which the terminal 100 determines a boundary condition using an area ID (for a detailed description, refer to the description of FIGS. 4a to 4d). This is because precise positioning is impossible to the extent that the boundary condition can be determined using a boundary distance. At step S325, when an event satisfying the boundary condition is generated, for example, if it is expected that the terminal 100 will get out of the area covered by the AR target, the terminal 100 requests a new AR target from the server 200 (S330).

Meanwhile, at step S340, the server 200 determines whether or not the terminal 100 moves in a direction along which the terminal 100 gets out of the area covered by the AR target based on the location and heading information of the terminal 100 received from the terminal 100 (S342). For a detailed description of the determination method based on the location and heading information of the terminal 100, reference can be made to FIGS. 8(a) and 8(b).

At step S342, if it is determined that the terminal 100 moves in the direction along which the terminal 100 gets out of the area covered by the AR target, the server 200 generates an AR target to be provided to the terminal 100 based on the heading information and the motion state (S344). A configuration for filtering AR targets to be provided by the server 200 based on the motion state, a configuration for differently configuring a cache area covered by an AR target according to a motion state, and a configuration for making different the resolution of an AR target according to the motion state have already been described. Furthermore, a configuration in which the server 200 provides an AR target having a good possibility (frequency) in the terminal 100 based on the heading information has already been described.

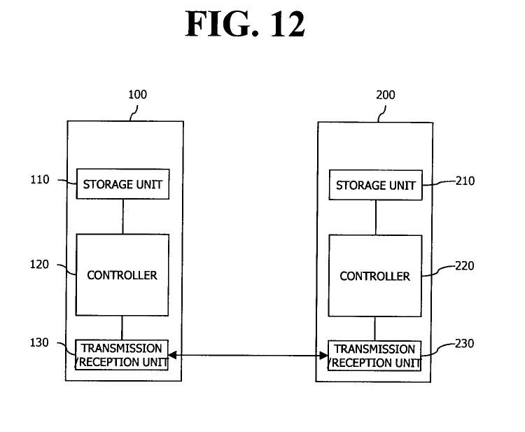

FIG. 12 is a block diagram of the terminal 100 and the server 200 in accordance with an embodiment disclosed in this specification.

As shown in FIG. 12, the terminal 100 includes a storage means 110, a controller 120, and a transmission and reception unit 130. The storage means 110 stores the methods according to the embodiments of FIGS. 1 to 11. The controller 120 controls the storage means 110 and the transmission and the reception unit 130. In particular, the controller 120 executes each of the methods stored in the storage means 110. Furthermore, the controller 120 sends the above-described signals through the transmission and reception unit 130.

Furthermore, as shown in FIG. 12, the server 200 includes storage means 210, a controller 220, and a transmission and reception unit 230. The storage means 210 stores the methods according to the embodiments of FIGS. 1 to 11. The controller 220 controls the storage means 210 and the transmission and reception unit 230. In particular, the controller 220 executes each of the methods stored in the storage means 210. Furthermore, the controller 220 sends the above-described signals through the transmission and reception unit 230.

As described above, the aforementioned embodiments should be constructed as being only illustrative from all aspects not as being restrictive. The scope of the present invention is defined by the following claims rather than the detailed description, and the meanings and scope of the claims and all changes or modified forms derived from their equivalents should be constructed as falling within the scope of the present invention.

1. A method of a terminal updating an Augmented Reality (AR) target, comprising steps of:
receiving an AR target, a boundary distance for a coverage area of the AR target, and at least one area ID list from a server;
determining whether or not a location of the terminal satisfies a boundary condition based on the boundary distance if precise positioning is possible;
determining whether or not a serving cell ID of the terminal satisfies the boundary condition based on the at least one area ID list if the precise positioning is impossible; and
sending an update request for the AR target to the server if it is determined that the boundary condition is satisfied.

2. The method of claim 1, wherein the at least one area ID list comprises an entire area ID list included in the coverage area and a boundary area ID list corresponding to the boundary of the coverage area.

3. The method of claim 2, wherein the boundary condition is satisfied if the serving cell ID of the terminal is included in both the entire area ID list and the boundary area ID list.

4. The method of claim 1, wherein the at least one area ID list comprises an outer area ID list corresponding to the boundary of the coverage area and an inner area ID list corresponding to an inside of the boundary of the coverage area.

5. The method of claim 4, wherein the boundary condition of the terminal is satisfied if the serving cell ID of the terminal is included in the outer area ID list and is not included in the inner area ID list.

6. The method of claim 1, wherein the at least one area ID list comprises an area ID list corresponding to an inside of the coverage area.

7. The method of claim 6, wherein the boundary condition of the terminal is satisfied if the serving cell ID of the terminal is not included in the area ID list corresponding to the inside of the coverage area.

8. The method of claim 1, wherein the at least one area ID list comprises a boundary area ID list corresponding to the coverage area.

9. The method of claim 8, wherein the boundary condition of the terminal is satisfied if the serving cell ID of the terminal is included in the boundary area ID list.

10. The method of claim 1, wherein the boundary condition of the terminal is satisfied if a distance between a location of the terminal at a point of time at which the AR target has been requested and a current location of the terminal is greater than or equal to the boundary distance.

11. The method of claim 10, wherein the boundary condition of the terminal is satisfied if a radius of the coverage area is greater than a sum of the distance between the location of the terminal at the point of time at which the AR target has been requested and the current location of the terminal and the boundary distance.

12. A method of a server generating an AR target, comprising steps of:
receiving an update request for the AR target from a terminal, wherein the request comprises a moving direction and motion state of the terminal;
determining whether or not the terminal substantially satisfies a boundary condition based on the moving direction of the terminal;
generating an AR target based on the moving direction and motion state of the terminal if the terminal substantially satisfies the boundary condition; and
sending the generated AR target to the terminal.

13. The method of claim 12, wherein the step of generating the AR target comprises a step of filtering the AR target, determining a coverage area of the AR target, or determining a resolution of the AR target based on the motion state of the terminal.

14. The method of claim 12, wherein the boundary condition is substantially satisfied if the moving direction of the terminal is a direction becoming distant from a center of a coverage area of the AR target.

15. The method of claim 12, wherein the step of generating the AR target comprises a step of limiting a coverage area of the AR target based on the moving direction of the terminal.
